(19) United States
(12) Patent Application Publication
(10) Pub. No.: US 2005/0184951 A1
(43) Pub. Date: Aug. 25, 2005

(54) Light emitting device and display apparatus having the same

(76) Inventors: Hyoung-Joo Kim, Euiwang-si (KR); In-Sun Hwang, Suwon-si (KR); Hyeon-Yong Jang, Osan-si (KR); Jin-Seob Byun, Seoul (KR); Sang-Yu Lee, Yongin-si (KR); Hae-Il Park, Seoul (KR)

Correspondence Address: CANTOR COLBURN, LLP, 55 GRIFFIN ROAD SOUTH, BLOOMFIELD, CT, 06002, US

(21) Appl. No.: 11/038,896

(22) Filed: Jan. 19, 2005

(30) Foreign Application Priority Data
Feb. 19, 2004 (KR) 2004-10929

(51) Int. Cl. G09G 3/36

(52) U.S. Cl. 345/102

(57) ABSTRACT

A light emitting device includes a light emitting body disposed on a substrate, which has light emitting sections apart from each other, a light generating member assembled with the light emitting body, and a light reflecting member disposed on the substrate between the light emitting sections. The light generating member receives driving voltages to generate light from the light emitting body, and the light reflecting member reflects light traveling onto the light reflecting member. The light emitting device also includes a light reflection body and a supporting member disposed on the substrate between the light emitting sections. A display device includes the light emitting device, a display panel receiving the light from the light emitting body, which displays images using the light and image data externally provided, and a container receiving the light emitting device and the display panel.

### BACKGROUND OF THE INVENTION

1. Field of the Invention

The present invention relates to a light emitting device and an image display apparatus having the light emitting device, and more particularly, to a planar light emitting device enhancing light efficiency and uniformity and an image display device employing the planar light emitting device.

2. Description of the Related Art

Liquid crystal display devices are a type of image display device utilizing the optical characteristics of liquid crystal. In a liquid crystal display device, liquid crystal molecules are subject to changes, such as twist, dispersion and/or bend, in response to electric fields applied to the liquid crystal. The liquid crystal display devices display images using such characteristics of liquid crystal.

In general, a liquid crystal display device includes a liquid crystal control module that controls arrangement of the liquid crystal, and a light providing module that provides light to the liquid crystal control module.

The liquid crystal control module includes a pair of substrates, a pair of electrodes and a liquid crystal layer interposed between the electrodes. The light providing module includes a light source generating light, and an optical member adjusting distribution of the light generated from the light source.

Quality of images displayed on a liquid crystal display device varies depending on the light source. Generally, a light emitting diode (LED) or a cold cathode fluorescent lamp (CCFL) is used as the light source. The light emitting diodes and the cold cathode fluorescent lamps generate light having low luminance uniformity. To compensate for such low luminance uniformity, the liquid crystal display devices are generally equipped with an optical member, such as a diffusion sheet, a prism sheet, etc.

In the liquid crystal display devices with a large display screen, the low luminance uniformity and other problems occur due to an increase in the size of display screen and the number of light sources.

Thus, planar light sources have been developed to overcome the problems. The planar light sources generally have a rectangular parallel piped shape. A planar light source includes multiple discharge spaces from which invisible light is generated. The invisible light is converted into visible light by fluorescent material coated on an inner surface of the planar light source.

However, since the light generated from each discharge space has non-uniform luminance distribution, the conventional planar light sources generate light having non-uniform luminance distribution. As a result, it has been difficult to improve the quality of images displayed by the conventional liquid crystal display devices.

### SUMMARY OF THE INVENTION

The above mentioned and other drawbacks and deficiencies of the prior art are overcome or alleviated by a planar light emitting device and a display device according to the present invention. In one embodiment, a light emitting device includes a substrate having a planar surface, a light emitting body disposed on the substrate, which includes light emitting sections that are apart from each other, a light generating member assembled with the light emitting body, which receives driving voltages to generate light from the light emitting body, and a light reflecting member disposed on the substrate between adjacent ones of the light emitting sections, which reflects light traveling onto the light reflecting member. The light emitting body may be one integral unit having bent portions and the light emitting sections. The bent portions each have end regions connected to corresponding ones, respectively, of the light emitting sections.

The light reflecting member may include a light diffusion pattern that scatters the light traveling onto the light reflecting member. The light diffusion pattern may include an embossing pattern having a plurality of protrusions each of which has a round top surface. In a different embodiment, the light diffusion pattern may include a plurality of protrusions that are discretely formed and each have a flat top surface.

The light emitting device may also include a light reflection body disposed on the substrate between adjacent ones of the light emitting sections. The light reflection body may be made of the same material as that of the light emitting body. The light reflecting member may be disposed on a top and/or bottom surface of the light reflection body.

In another embodiment, the light emitting device may further include a supporting member disposed on the substrate between adjacent ones of the light emitting sections. The light reflecting member may be disposed on a side and/or bottom surface of the supporting member.

In another embodiment, a display device includes a light emitting device having a light emitting body disposed on a substrate to generate light, which includes light emitting sections that are apart from each other, and a light reflecting member disposed on the substrate between adjacent ones of the light emitting sections, which reflects light traveling onto the light reflecting member, a display panel receiving the light from the light emitting body, which displays images using the light and image data externally provided, and a container that receives the light emitting device and the display panel.

This application relies for priority upon Korean Patent Application No. 2004-10929 filed on Feb. 19, 2004, the contents of which are herein incorporated by reference in its entirety.

These and other features and advantages of the present invention will become apparent from the following detailed description of illustrative embodiments thereof, which is to be read in connection with the accompanying drawings.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is a perspective view illustrating a planar light emitting device according to an exemplary embodiment of the present invention;

FIG. 2 is a cross-sectional view of the planar light emitting device taken along line A₁-A₂ in FIG. 1;

FIG. 3 is a perspective view illustrating a planar light emitting device according to another exemplary embodiment of the present invention;

FIG. 4 is a cross-sectional view of a planar light emitting device according to another exemplary embodiment of the present invention;

FIG. 5 is a cross-sectional view of a planar light emitting device according to another exemplary embodiment of the present invention;

FIG. 6 is a cross-sectional view of a planar light emitting device according to another exemplary embodiment of the present invention;

FIG. 7 is a perspective view illustrating a planar light emitting device according to another exemplary embodiment of the present invention;

FIG. 8 is a cross-sectional view of the planar light emitting device taken along line B₁-B₂ in FIG. 7;

FIG. 9 is a cross-sectional view of a planar light emitting device according to another exemplary embodiment of the present invention;

FIG. 10 is a cross-sectional view of a planar light emitting device according to another exemplary embodiment of the present invention;

FIG. 11 is an exploded perspective view illustrating a display device according to an exemplary embodiment of the present invention; and

FIG. 12 is an exploded perspective view illustrating a display according to an exemplary embodiment of the present invention.

### DETAILED DESCRIPTION OF THE INVENTION

Detailed illustrative embodiments of the present invention are disclosed herein. However, specific structural and functional details disclosed herein are merely representative for purposes of describing exemplary embodiments of the present invention.

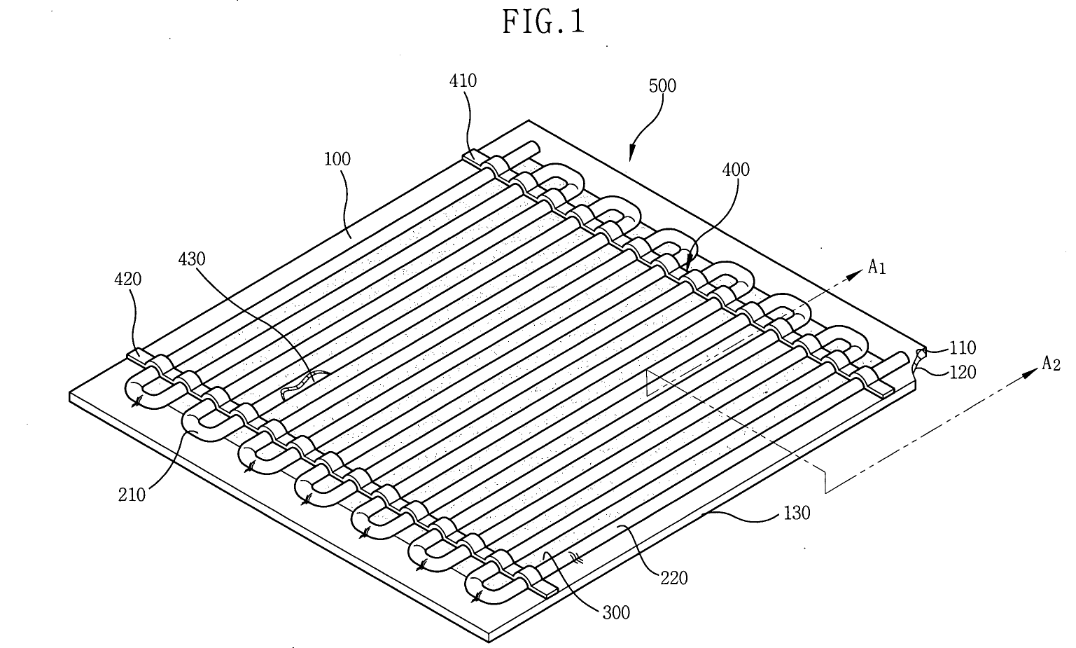

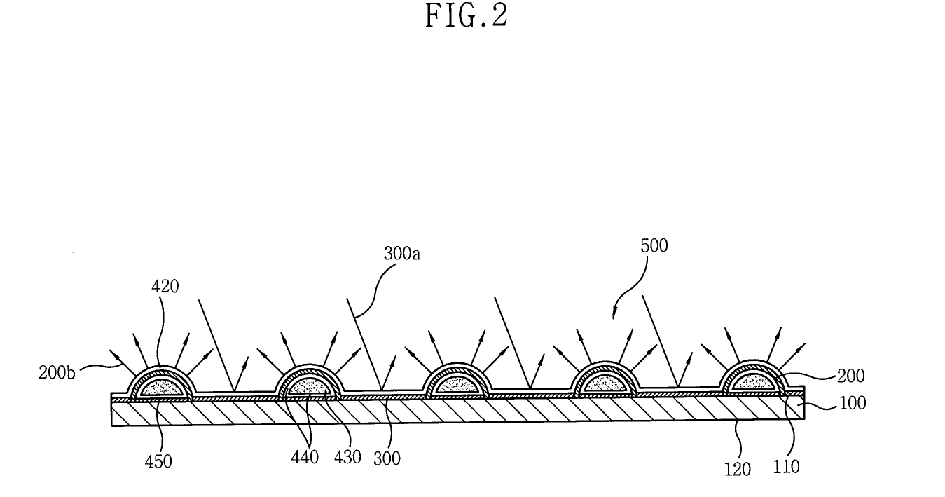

FIG. 1 is a perspective view illustrating a planar light emitting device according to an exemplary embodiment of the present invention, and FIG. 2 is a cross-sectional view of the planar light emitting device taken along line A₁-A₂ in FIG. 1.

Referring to FIGS. 1 and 2, a planar light emitting device 500 includes a substrate 100, a light emitting body 200, a light reflecting member 300, and a light generating member 400. The substrate 100 is made of material transmitting light, for example, glass. The substrate 100 has a plate shape having a first surface 110, a second surface 120 opposite to the first surface 110, and side surfaces 130 connecting the first and second surfaces 110 and 120.

The light emitting body 200 is disposed on the first surface 110 of the substrate 100. The light emitting body 200 has, for example, a serpentine shape. In this embodiment, the light emitting body 200 is one integral unit having bent portions 210 and light emitting sections 220. The bent portions 210 each have end regions that are each connected with corresponding one of the light emitting sections 220. In particular, each bent portion 210 in this embodiment is U-shaped and has two end regions each of which is connected with corresponding one of the light emitting sections 220. The light emitting sections 220 are arranged substantially parallel with each other and apart from each other as shown in FIG. 1.

The light emitting body 200 is attached on the substrate 100 by adhesive including glass. The light emitting body 200 and the substrate 100 are sealed by a sealing member, for example, lead glass. The light emitting body 200 has a cross-section view of hemisphere in this embodiment. It should be noted that the light emitting body may have a different cross-sectional view, for example, an angular shape.

The light generating member 400 includes a first electrode 410, a second electrode 420, a discharge gas 430, and a fluorescent layer 440. The light generating member 400 operates to generate light 200b from the light emitting body 200. In this embodiment, the first and second electrodes 410 and 420 are disposed side areas of the light emitting body 200. As shown in FIG. 1, the first and second electrodes 410 and 420 are spaced apart from each other and disposed at the end portions of the light emitting sections 220. In other words, the first electrode 410 is disposed on first end portions of the light emitting sections 220, and the second electrode 420 is disposed on second end portions of the light emitting sections 220. The first and second electrodes 410 and 420 each have a long band shape. The first and second electrodes 410 and 420 are formed, for example, by spraying liquefied conducting material. A conducting tape may be used as the first and second electrodes 410 and 420. Also, liquefied metal may be sprayed to form the first and second electrodes 410 and 420. It is noted that the first and second electrodes 410 and 420 may be disposed inside the light emitting body 200, or on the second surface 120 of the substrate 100.

First and second driving voltages are applied to the first and second electrodes 410 and 420, respectively. The voltage difference between the first and second driving voltages is enough to discharge the discharge gas 430 disposed inside the light emitting body 220.

The discharge gas 430 includes mercury (Hg), neon (Ne), Argon (Ar), Xenon (Xe), Krypton (Kr), etc. The discharge gas 430 of the light emitting body 200 generates the invisible light such as ultraviolet light.

The fluorescent layer 440 is coated on an inner surface of the light emitting body 200. The fluorescent layer 440 may also be coated on a portion of the first surface 110 of the substrate 100, which is covered by the light emitting body 200. In this embodiment, the fluorescent layer 440 is formed on an internal light reflecting member 450 as well as the inner surface of the light emitting body 200. The fluorescent layer 400 converts the invisible light generated from the discharge gas 430 into visible light.

The internal light reflecting member 450 is disposed on the first surface 110 of the substrate 100 inside the light emitting body 200. In this embodiment, the internal light reflecting member 450 is disposed between the fluorescent layer 440 and the first surface 110 of the substrate 100. The internal light reflecting member 450 includes material that has high reflectivity, such as metal. The internal light reflecting member 450 has a thin plate shape. The internal light reflecting member 450 reflects the visible and invisible light traveling onto the substrate 100. As a result, the amount of the visible and invisible light increases.

The planar light emitting device 500 also includes an external light reflecting member 300 for enhancing uniformity of luminance. The external light reflecting member 300 is disposed on an area of the substrate 100 other than the light emitting body 200. In this embodiment, the external light reflecting member 300 is disposed on the substrate 100 between adjacent ones of the light emitting sections 220. The external light reflecting member 300 includes a thin film formed on the first surface 110 of the substrate 100. The external light reflecting member 300 reflects external light 300a traveling onto the substrate 100, such as sunlight, light generated from another lighting device, light generated from the planar light emitting device 500 and then reflected back to the planar light emitting device 500.

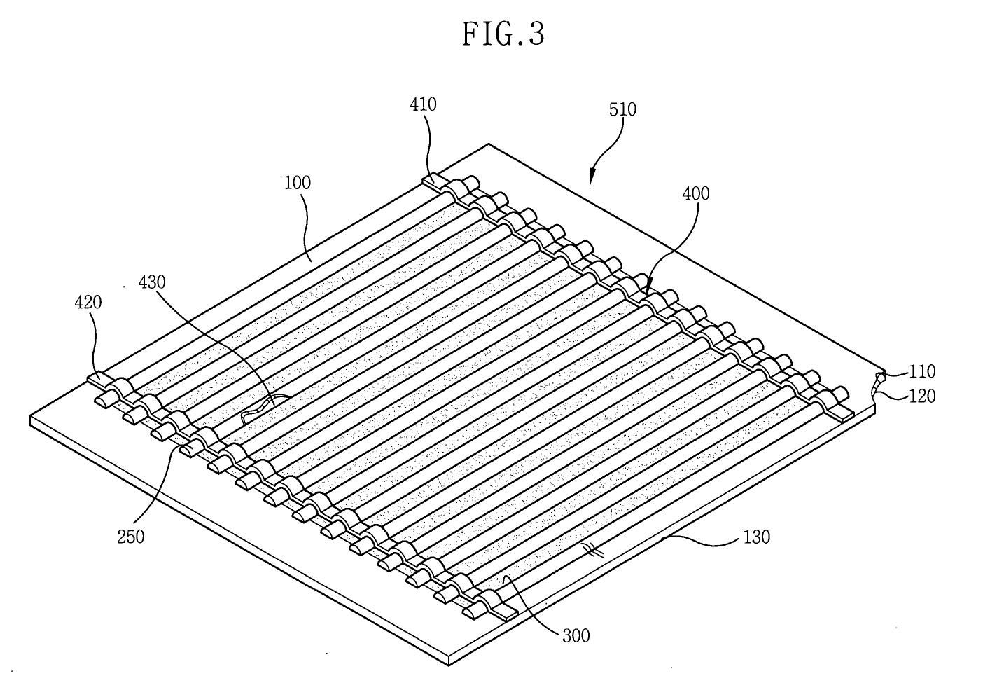

FIG. 3 is a perspective view illustrating a planar light emitting device according to another exemplary embodiment of the present invention. In FIG. 3, the same parts as those shown in FIGS. 1 and 2 are represented with like reference numerals and their explanation will be omitted to avoid description duplication.

Referring to FIG. 3, the planar light emitting device 510 includes multiple light emitting bodies 250 disposed on the substrate 100. Each the light emitting bodies 250 has a straight shape. The light emitting bodies 250 are arranged substantially parallel with each other. The light emitting bodies 250 are spaced apart with each other.

The external light reflecting member 300 is disposed on the substrate 100 between the light emitting bodies 250. The light emitting bodies 250 each include the discharge gas 430. The discharge gas 430 has uniform pressure inside the respective light emitting bodies 250. The discharge gas 430 may be injected into the light emitting bodies 250 by a getter.

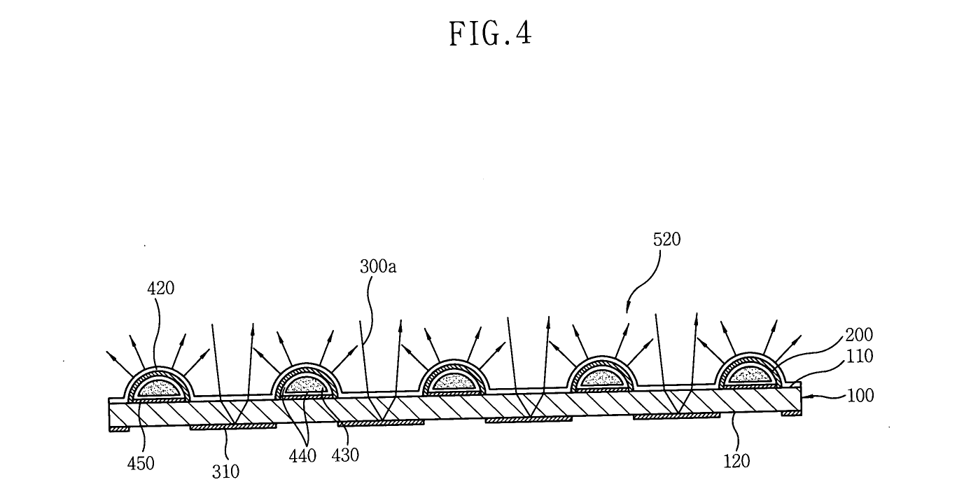

FIG. 4 is a cross-sectional view of a planar light emitting device according to another exemplary embodiment of the present invention. In FIG. 4, the same parts as those shown in FIGS. 1 and 2 are represented with like reference numerals and their explanation will be omitted to avoid description duplication.

Referring to FIG. 4, the planar light emitting device 520 includes an external light reflecting member 310 formed on the second surface 120 of the substrate 100. The second surface 120 is opposite to the first surface on which the light emitting body 200 is disposed. The external light reflecting member 310 is disposed on the second surface 120 between the light emitting sections of the light emitting body 200. The external light reflecting member 310 is formed on the second surface 120 by, for example, printing metal in liquid state or attaching a thin film on the second surface 120.

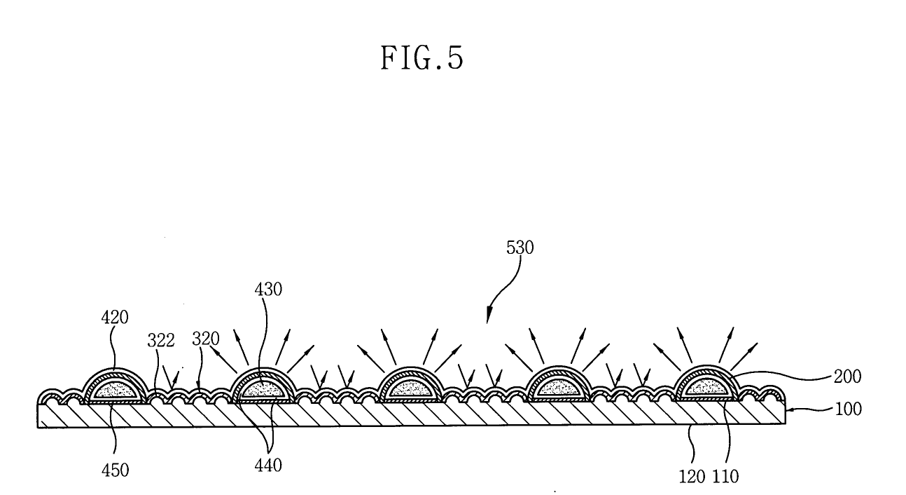

FIG. 5 is a cross-sectional view of a planar light emitting device according to another exemplary embodiment of the present invention. In FIG. 5, the same parts as those shown in FIGS. 1 and 2 are represented with like reference numerals and their explanation will be omitted to avoid description duplication.

Referring to FIG. 5, the planar light emitting device 530 includes an external light reflecting member 320 formed on the first surface 110 of the substrate 100. In this embodiment, the external light reflecting member 320 may be disposed on the second surface 120, instead of the first surface 110, of the substrate 100. The external light reflecting member 320 is disposed on the substrate 100 between the light emitting sections of the light emitting body 200. The external light reflecting member 320 has a thin film shape.

The external light reflecting member 320 has a diffusion pattern 322 to scatter the light reflected on the external light reflecting member 320. The diffusion pattern 322 includes, for example, an embossing pattern having multiple protrusions each of which has a round top surface. The protrusions of the embossing pattern each have a cross-section view of hemisphere. The diffusion pattern 322 with the embossing pattern increases the uniformity of luminance distribution of the light.

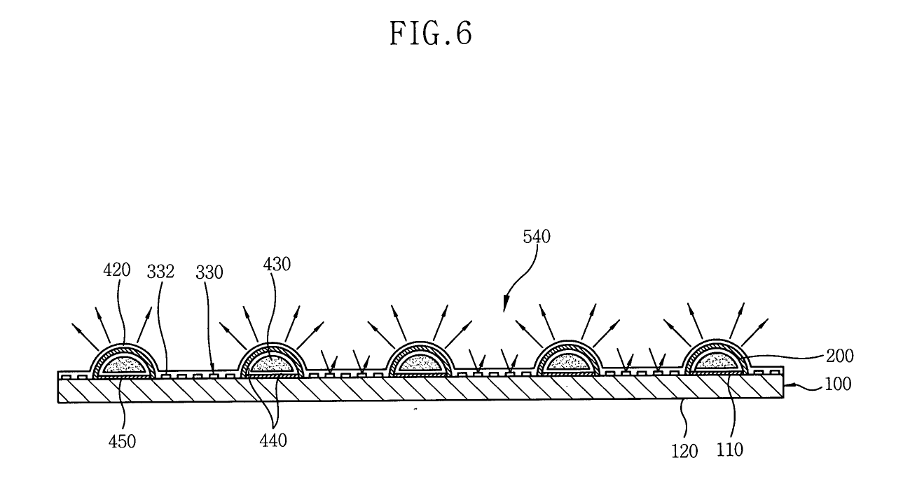

FIG. 6 is a cross-sectional view of a planar light emitting device according to another exemplary embodiment of the present invention. In FIG. 6, the same parts as those shown in FIGS. 1 and 2 are represented with like reference numerals and their explanation will be omitted to avoid description duplication.

Referring to FIG. 6, the planar light emitting device 540 includes an external light reflecting member 330 disposed on the first surface 110 of the substrate 100. In this embodiment, the external light reflecting member 320 may be disposed on the second surface 120, instead of the first surface 110, of the substrate 100.

The external light reflecting member 330 includes a light diffusion pattern 332 for diffusing or scattering the light reflected on the external light reflecting member 330. The light diffusion pattern 332 of this embodiment has multiple small protrusions that are discretely formed. The protrusions of the light diffusion pattern 332 each have, for example, a flat top surface. The external light reflecting member 330 with the light diffusion pattern 332 improves the light efficiency and uniformity of luminance distribution.

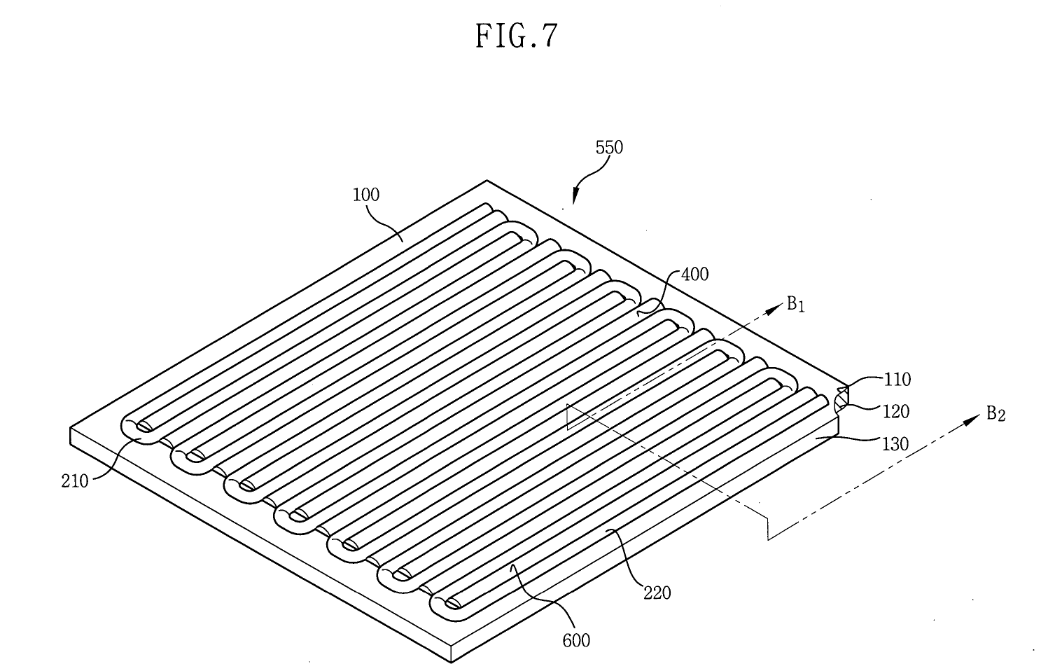

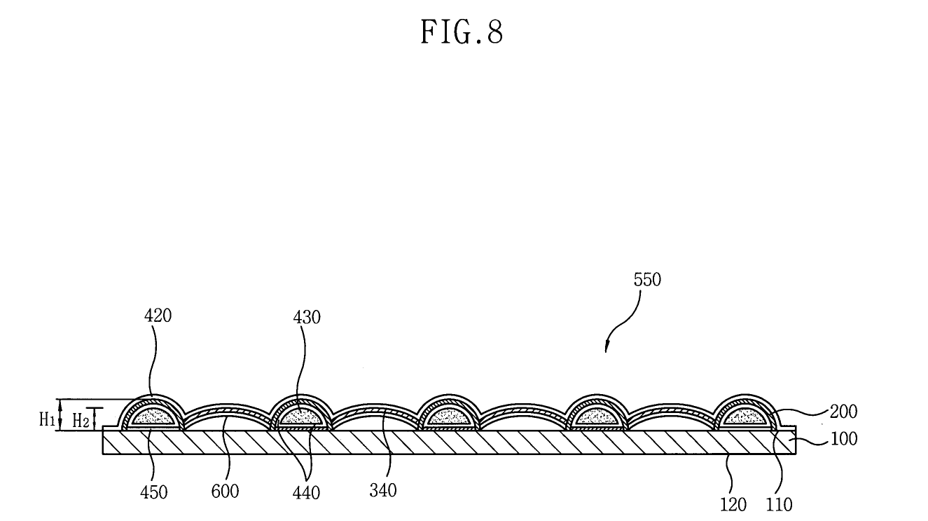

FIG. 7 is a perspective view illustrating a planar light emitting device according to another exemplary embodiment of the present invention, and FIG. 8 is a cross-sectional view of the planar light emitting device taken along line B₁-B₂ in FIG. 7. In FIGS. 7 and 8, the same parts as those shown in FIGS. 1 and 2 are represented with like reference numerals and their explanation will be omitted to avoid description duplication.

Referring to FIGS. 7 and 8, the planar light emitting device 550 includes a light reflection body 600. The light reflection body 600 is disposed on the first surface 110 of the substrate 100. The light reflection body 600 is disposed between the light emitting sections 220 of the light emitting body 200 that has, for example, a serpentine shape. The light reflection body 600 may include the same material, for example glass, as that of the light emitting body 200.

The light reflection body 600 may have different shapes in its cross-sectional view. In this embodiment, the light reflection body 600 has an arch shape. As shown in FIG. 8, the light emitting body 200 has a first height H₁ and the light reflection body 600 has a second height H₂, which are measured from the first surface 110 of the substrate 100. In this embodiment, the first height H₁ of the light emitting body 200 is larger than the second height H₂ of the light reflection body 600.

The planar light emitting device 550 includes an external light reflecting member 340 disposed on the light reflection body 600. In this embodiment, the external light reflecting member 340 is disposed on the top surface of the light reflection body 600. It is noted that the external light reflecting member 340 may be disposed on the bottom surface of the light reflection body 600. The external light reflecting member 300 may be formed by coating liquid-state material on the light reflection body 600 and curing the coated material thereon. The external light reflecting member 300 reflects the light traveling onto the substrate 100 to enhance light efficiency and uniformity of luminance distribution.

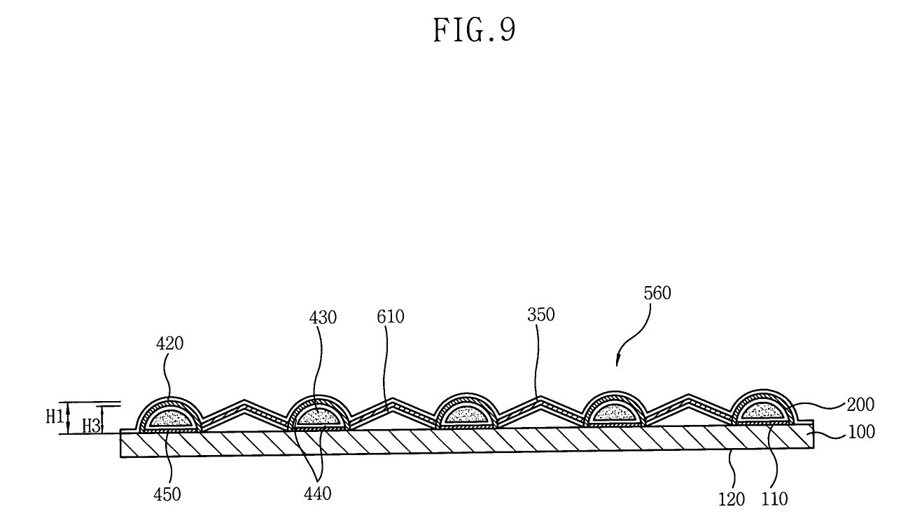

FIG. 9 is a cross-sectional view of a planar light emitting device according to another exemplary embodiment of the present invention. In FIG. 9, the same parts as those shown in FIGS. 1 and 2 are represented with like reference numerals and their explanation will be omitted to avoid description duplication.

Referring to FIG. 9, the planar light emitting device 560 includes a light reflection body 610. The light reflection body 610 is disposed on the first surface 110 of the substrate 100. The light reflection body 610 is disposed between the light emitting sections of the light emitting body 200. The light reflection body 610 includes the same material as that of the light emitting body 200. For example, the same material is glass.

The light reflection body 610 has a cross-sectional view of a triangular shape or a trapezoidal shape. The light reflection body 610 has a height H₃ measured from the first surface 110 of the substrate 100, which is smaller than the height H₁ of the light emitting body 200.

The planar light emitting device 560 includes an external light reflecting member 350 disposed on the outer or top surface of the light reflection body 610. It is noted that the external light reflecting member 350 may be disposed on the inner or bottom surface of the light reflection body 610. In this case, the external light reflecting member 300 may be disposed between the light reflection body 610 and the substrate 100. The external light reflecting member 350 may be formed by coating liquid-state material on the light reflection body 610 and curing the coated material thereon.

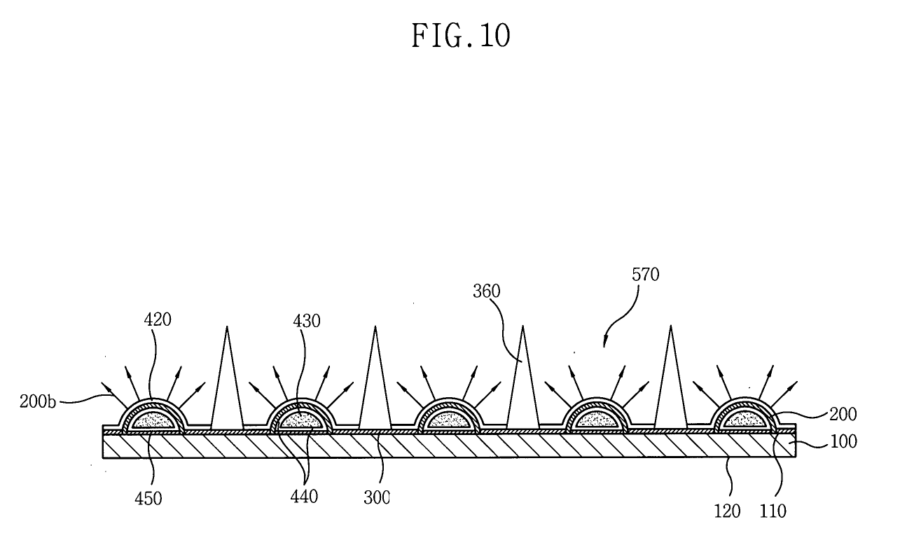

FIG. 10 is a cross-sectional view of a planar light emitting device according to another exemplary embodiment of the present invention. In FIG. 10, the same parts as those shown in FIGS. 1 and 2 are represented with like reference numerals and their explanation will be omitted to avoid description duplication. Referring to FIG. 10, the planar light emitting device 570 includes a supporting member 360 disposed on the substrate 100. The supporting member 360 is disposed between the adjacent ones of the light emitting sections of the light emitting body 200. The supporting member 360 has, for example, a cone shape. The supporting member 360 supports an optical member, for example, a diffusion plate, a display panel, etc.

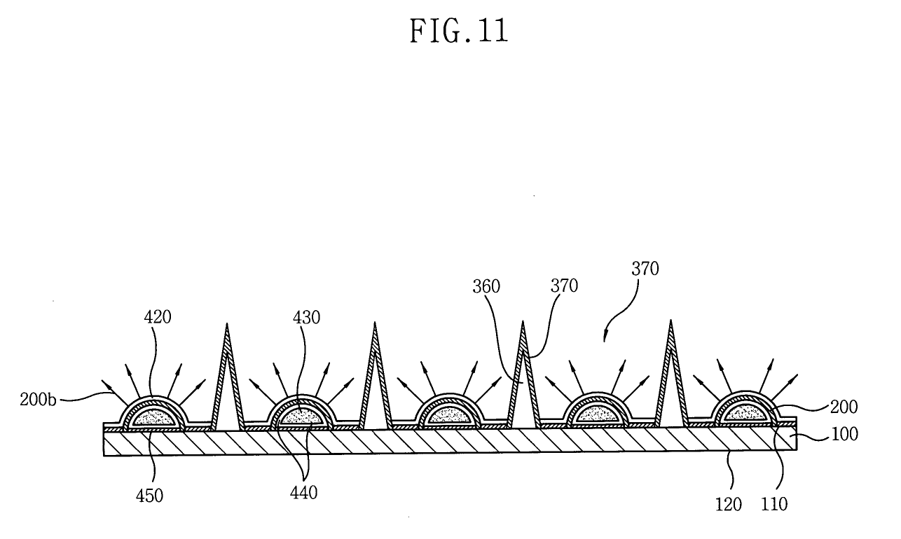

In this embodiment, the supporting member 360 is disposed on the external light reflecting member 300. The supporting member 360 may be attached on the substrate 100 or the external light reflecting member 300 by means of adhesive or double-faced adhesive tape. In a different embodiment, however, the external light reflecting member 370 may be formed on the outer or side surface of the supporting member 360 (referring to FIG. 11). In this case, the external light reflecting member 370 is formed by coating light reflecting material on the outer or side surface of the supporting member 360.

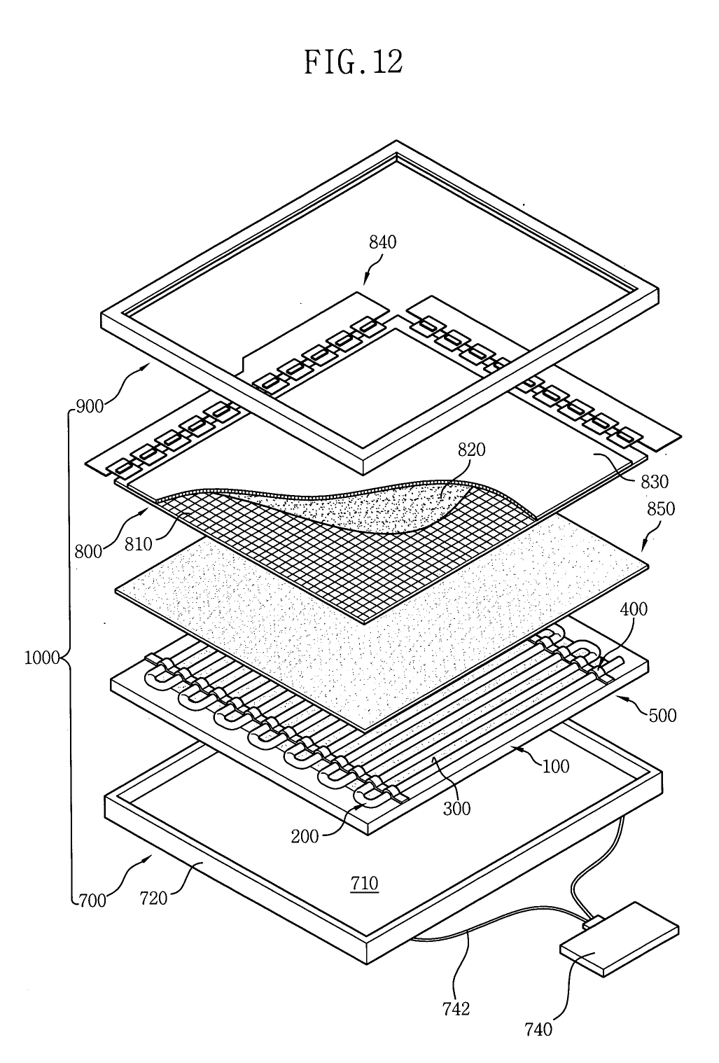

FIG. 12 is an exploded perspective view illustrating a display according to an exemplary embodiment of the present invention. In this embodiment, the display device includes the planar light emitting device 500 in FIGS. 1 and 2. It should be noted that the display device in FIG. 12 can include any one of the above-described embodiments of the planar light emitting device.

Referring to FIG. 12, the display device 1000, for example, a liquid crystal display device, includes a receiving container 700, a liquid crystal display panel 800, a chassis 900 as well as the planar light emitting device 500. The receiving container 700 includes a bottom plate 710 and sidewalls 720 extended from the edges of the bottom plate 710 to form a receiving space. The receiving container 700 receives the planar light emitting device 500 and the liquid crystal display panel 800.

The bottom plate 710 has a size equal to or larger than that of the planar light emitting device 500, so that the receiving space is large enough to receive the planar light emitting device 500. The bottom plate 710 has substantially same shape as the planar light emitting device 500. For example, the bottom plate 710 and the planar light emitting device 500 have a rectangular shape. The sidewalls 720 are extended from the edges of the bottom plate 710 in a direction substantially perpendicular to the surface of the bottom plate 710. The sidewalls 720 each have a height to provide an appropriate size of the receiving space to securely receive the planar light emitting device 500.

The display device 1000 also includes a discharge voltage applying module (not shown) and an inverter 740. The discharge voltage applying module applies first and second driving voltages to the first and second electrodes 410 and 420 (referring FIG. 1) of the planar light emitting device 500, respectively. The inverter 740 is electrically connected to the discharge voltage applying module by wire 742, so that the inverter 740 applies the first and second driving voltages to the discharge voltage applying module.

The liquid crystal display panel 800 displays images by means of the light generated from the planar light emitting device 500 and image data containing image information to be displayed. The liquid crystal display panel 800 includes a thin film transistor (TFT) substrate 810, a liquid crystal layer 820, a color filter substrate 830 and a driving module 840, which operate in association with the image data and the light.

The TFT substrate 810 includes pixel electrodes arranged in a matrix form, thin film transistors providing the driving voltages to the pixel electrodes, gate lines and data lines. The color filter substrate 830 includes color filters facing the pixel electrodes, respectively, and a common electrode formed on the color filters. The liquid crystal layer 820 is interposed between the TFT substrate 810 and the color filter substrate 830.

The chassis 900 surrounds edge portions of the color filter substrate 830. The chassis 900 is combined with the receiving container 700 by a hook formed on the sidewalls 720 of the receiving container 700. The chassis 900 protects and fixes the liquid crystal display panel 800. A light diffusing member 850 diffuses the light generated from the planar light emitting device 500. Optionally, a diffusing plate and one or more optical sheets may be disposed on the light diffusing member 850. Also, a mold frame (not shown) may be disposed between the planar light emitting device 500 and the light diffusing member 850. The mold frame is configured to be placed at edge regions of the planar light emitting device 500 and to support the light diffusing member 850.

The display device 1000 having the planar light emitting device 500 according to the present invention enhances the light efficiency and uniformity of luminance distribution. Thus, the display quality of the display device 1000 is improved.

Having described the exemplary embodiments of the light emitting device and the display device employing the same according to the present invention, modifications and variations can be readily made by those skilled in the art in light of the above teachings. It is therefore to be understood that, within the scope of the appended claims, the present invention can be practiced in a manner other than as specifically described herein.

1. A light emitting device comprising:
a substrate having a planar surface;
a light emitting body disposed on the substrate, the light emitting body including light emitting sections that are apart from each other;
a light generating member assembled with the light emitting body, the light generating member receiving driving voltages to generate light from the light emitting body; and
a light reflecting member disposed on the substrate between adjacent ones of the light emitting sections, the light reflecting member reflecting light traveling onto the light reflecting member.

2. The light emitting device of claim 1, wherein the light emitting body is one integral unit having bent portions and the light emitting sections, the bent portions each having end regions connected to corresponding ones, respectively, of the light emitting sections.

3. The light emitting device of claim 2, wherein the light emitting sections are arranged substantially parallel with each other.

4. The light emitting device of claim 2, wherein the light emitting body has a cross-sectional view of a hemisphere shape.

5. The light emitting device of claim 1, wherein the substrate has a first surface on which the light emitting body is disposed, and a second surface opposite to the first surface.

6. The light emitting device of claim 5, wherein the light reflecting member is disposed on the first surface of the substrate.

7. The light emitting device of claim 5, wherein the light reflecting member is disposed on the second surface of the substrate, the substrate being made of material transmitting light.

8. The light emitting device of claim 1, wherein the light reflecting member includes a light diffusion pattern that scatters the light traveling onto the light reflecting member.

9. The light emitting device of claim 8, wherein the light diffusion pattern includes an embossing pattern having a plurality of protrusions each of which has a round top surface.

10. The light emitting device of claim 8, wherein the light diffusion pattern includes a plurality of protrusions that are discretely formed and each have a flat top surface.

11. The light emitting device of claim 1, wherein the light generating member includes:
electrodes receiving the driving voltages;
discharge gas disposed inside the light emitting body; and
a fluorescent layer formed on an inner surface of the light emitting body.

12. The light emitting device of claim 11, wherein the electrodes include:
a first electrode disposed at first end portions of the light emitting sections; and
a second electrode disposed at second end portions of the light emitting sections.

13. The light emitting device of claim 12, wherein the electrodes each include electrically conductive material formed on surface of the light emitting body and the substrate.

14. The light emitting device of claim 1, further including a light reflection body disposed on the substrate between adjacent ones of the light emitting sections.

15. The light emitting device of claim 14, wherein the light reflection body includes material same as material of the light emitting body.

16. The light emitting device of claim 14, wherein the light reflecting member is disposed on a top surface of the light reflection body.

17. The light emitting device of claim 14, wherein the light reflecting member is disposed on a bottom surface of the light reflection body.

18. The light emitting device of claim 14, wherein the light reflection body has a height smaller than a height of the light emitting body, the heights being measured from the planar surface of the substrate.

19. The light emitting device of claim 14, wherein the light reflection body has a cross-sectional view of an arch shape.

20. The light emitting device of claim 14, wherein the light reflection body has a cross-sectional view of a triangular shape.

21. The light emitting device of claim 14, wherein the light reflection body has a cross-sectional view of a trapezoidal shape.

22. The light emitting device of claim 1, further including a supporting member disposed on the substrate between adjacent ones of the light emitting sections, the supporting member supporting an optical member.

23. The light emitting device of claim 22, wherein the light reflecting member is disposed on a side surface of the supporting member.

24. The light emitting device of claim 22, wherein the light reflecting member is disposed on a bottom surface of the supporting member.

25. The light emitting device of claim 22, wherein the supporting member has a cone shape.

26. The light emitting device of claim 1, further including another light reflecting member disposed on the substrate inside the light emitting body.

27. A display device comprising:
a light emitting device including:
a light emitting body disposed on a substrate to generate light, the light emitting body including light emitting sections that are apart from each other; and
a light reflecting member disposed on the substrate between adjacent ones of the light emitting sections, the light reflecting member reflecting light traveling onto the light reflecting member;
a display panel receiving the light from the light emitting body, the display panel displaying images using the light and image data externally provided; and
a container that receives the light emitting device and the display panel.

28. The display device of claim 27, wherein the light emitting sections are arranged substantially parallel with each other.

29. The display device of claim 27, wherein the light emitting sections have a substantially identical length.

30. The display device of claim 27, wherein the light reflecting member has a film shape coated on the substrate.

31. The display device of claim 27, wherein the light reflecting member includes an embossing pattern to diffuse the light traveling onto the light reflecting member.

32. The display device of claim 27, wherein the light reflecting member includes a plurality of protrusions to diffuse the light traveling onto the light reflecting member, the protrusions being discretely formed and each having a flat top surface.

33. The display device of claim 27, further including a light reflection body disposed on the substrate between adjacent ones of the light emitting sections.

34. The display device of claim 33, wherein the light reflecting member is disposed on one of top and bottom surfaces of the light reflection body.

35. The display device of claim 33, wherein the light reflection body has a cross-sectional view of an arch shape, a triangular shape, or a trapezoidal shape.

36. The display device of claim 27, further including a supporting member disposed on the substrate between adjacent ones of the light emitting sections, the supporting member supporting an optical member.
